(19) United States
(12) Patent Application Publication
(10) Pub. No.: US 2024/0403001 A1
(43) Pub. Date: Dec. 5, 2024

(54) CODE RECOMMENDATION METHOD AND APPARATUS, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Junwei XING, Beijing (CN); Hui LI, Beijing (CN); Wanpeng NIU, Beijing (CN); Lili ZHANG, Beijing (CN); Chuqing WANG, Beijing (CN); Sai GAO, Beijing (CN); Haonan FANG, Beijing (CN); Xiangfei MIN, Beijing (CN); Jie SHAO, Beijing (CN); Yunpeng PENG, Beijing (CN)

(73) Assignee: BEIJING BAIDU NETCOM SCIENCE TECHNOLOGY CO., LTD., Beijing (CN)

(21) Appl. No.: 18/803,034

(22) Filed: Aug. 13, 2024

(30) Foreign Application Priority Data
Jun. 19, 2024 (CN) 202410797310.4

(51) Int. Cl. G06F 8/33

(52) U.S. Cl. CPC G06F 8/33

(57) ABSTRACT

There is provided a code recommendation method and apparatus, an electronic device and a storage medium, which relates to the field of software development technologies, artificial intelligence technologies, or the like. A specific implementation includes: acquiring a relevant code segment required by a recommended code from a current code file; acquiring code dependence information required by the recommended code; and performing code recommendation based on the relevant code segment, the code dependence information and a pre-trained code recommendation model.

The present application claims the priority of Chinese Patent Application No. 2024107973104, filed on Jun. 19, 2024, with the title of “CODE RECOMMENDATION METHOD AND APPARATUS, ELECTRONIC DEVICE AND STORAGE MEDIUM”. The disclosure of the above application is incorporated herein by reference in its entirety.

### FIELD OF THE DISCLOSURE

The present disclosure relates to the field of computer technologies, and particularly relates to the fields of software development technologies, artificial intelligence technologies, or the like, and particularly to a code recommendation method and apparatus, an electronic device and a storage medium.

### BACKGROUND OF THE DISCLOSURE

Code recommendation is a quite important scenario for application of a code recommendation model. Specifically, using the code recommendation model, a code recommendation tool can predict a code to be written by a developer according to currently edited code content, and further display a recommended code at a current cursor stop position, such that the developer can refer to and use the recommended code conveniently.

Existing code recommendation tool may predict a following code according to a previous code, and may also predict an intermediate code according to the previous code and the following code.

### SUMMARY OF THE DISCLOSURE

The present disclosure provides a code recommendation method and apparatus, an electronic device and a storage medium.

According to an aspect of the present disclosure, there is provided a method for code recommendation, including:
acquiring a relevant code segment required by a recommended code from a current code file;
acquiring code dependence information required by the recommended code; and
performing code recommendation based on the relevant code segment, the code dependence information and a pre-trained code recommendation model.

According to another aspect of the present disclosure, there is provided an electronic device, including:
at least one processor; and
a memory communicatively connected with the at least one processor;
wherein the memory stores instructions executable by the at least one processor, and the instructions are executed by the at least one processor to enable the at least one processor to perform a method for code recommendation, wherein the method for code recommendation includes:
acquiring a relevant code segment required by a recommended code from a current code file;
acquiring code dependence information required by the recommended code; and
performing code recommendation based on the relevant code segment, the code dependence information and a pre-trained code recommendation model.

According to still another aspect of the present disclosure, there is provided a non-transitory computer readable storage medium with computer instructions stored thereon, wherein the computer instructions are used for causing a method for code recommendation, wherein the method for code recommendation includes:
acquiring a relevant code segment required by a recommended code from a current code file;
acquiring code dependence information required by the recommended code; and
performing code recommendation based on the relevant code segment, the code dependence information and a pre-trained code recommendation model.

It should be understood that the statements in this section are not intended to identify key or critical features of the embodiments of the present disclosure, nor limit the scope of the present disclosure. Other features of the present disclosure will become apparent from the following description.

### BRIEF DESCRIPTION OF DRAWINGS

The drawings are used for better understanding the present solution and do not constitute a limitation of the present disclosure. In the drawings,

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure;

FIG. 4 is a schematic diagram according to a fourth embodiment of the present disclosure;

FIG. 5 is a schematic diagram according to a fifth embodiment of the present disclosure;

FIG. 6 is a schematic diagram according to a sixth embodiment of the present disclosure; and

FIG. 7 is a block diagram of an electronic device configured to implement a method according to the embodiment of the present disclosure.

### DETAILED DESCRIPTION OF PREFERRED EMBODIMENTS

The following part will illustrate exemplary embodiments of the present disclosure with reference to the drawings, including various details of the embodiments of the present disclosure for a better understanding. The embodiments should be regarded only as exemplary ones. Therefore, those skilled in the art should appreciate that various changes or modifications can be made with respect to the embodiments described herein without departing from the scope and spirit of the present disclosure. Similarly, for clarity and conciseness, the descriptions of the known functions and structures are omitted in the descriptions below.

Apparently, the embodiments to be described are merely a part rather than all of the embodiments of the present disclosure. All other embodiments obtained by a person of ordinary skill in the art based on the embodiments of the present disclosure without creative efforts shall fall within the protection scope of the present disclosure.

It should be noted that a terminal device in the embodiments of the present disclosure may include, but is not limited to, a mobile phone, a personal digital assistant (PDA), a wireless handheld device, a tablet computer, and other smart devices; a display device may include, but not limited to, a personal computer, a television, and other devices with a display function.

In addition, the term “and/or” only describes an association relationship between associated objects, and indicates that three relationships may exist. For example, A and/or B may indicate three cases: only A exists; both A and B exist; and only B exists. In addition, in this specification, the symbol “/” generally indicates that associated objects have a relationship of “or”.

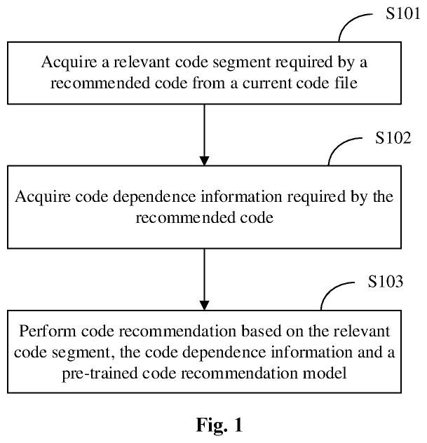

FIG. 1 is a schematic diagram according to a first embodiment of the present disclosure; as shown in FIG. 1, the present embodiment provides a method for code recommendation, which may include the following steps:
S101: acquiring a relevant code segment required by a recommended code from a current code file;
S102: acquiring code dependence information required by the recommended code; and
S103: performing code recommendation based on the relevant code segment, the code dependence information and a pre-trained code recommendation model.

An apparatus for code recommendation may serve as the subject for executing the method for code recommendation according to the present embodiment, and may be an electronic entity or software-integrated software application, and when the apparatus for code recommendation is used, in the process of writing codes by a developer, code recommendation may be performed on an incomplete code file for the developer, thus effectively improving a code development efficiency.

In the present embodiment, the current code file is one incomplete code file written by the developer. In the method for code recommendation according to the present embodiment, codes are recommended in a development process of a research and development person, such that the research and development person can use the recommended codes as far as possible, development can be assisted, a code completion time can be shortened, and development progress can be accelerated.

In order to improve accuracy of code recommendation, in the present embodiment, during code recommendation, the relevant code segment in the code file may be combined, such that the recommended code is more fit to the current code file.

In the present embodiment, in order to further improve the accuracy of code recommendation, it is further necessary to acquire the code dependence information required by the recommended code. The code dependence information is not information of the current code file and can be acquired from the outside of the current code file.

Further, the pre-trained code recommendation model can be adopted based on the relevant code segment and the code dependence information, such that code recommendation can be performed more accurately and more effectively.

The code recommendation model in the present embodiment is implemented by using a generative model which may also be referred to as a generative language model (GLM) or a generative large language model.

In the method for code recommendation according to the present embodiment, code recommendation is performed based on the relevant code segment, the code dependence information and the pre-trained code recommendation model, such that when the code recommendation model recommends the code, reference may be made to both the relevant code segment and the code dependence information, thus effectively improving the accuracy of code recommendation, increasing an adoption rate of the recommended code, and then effectively improving the development efficiency.

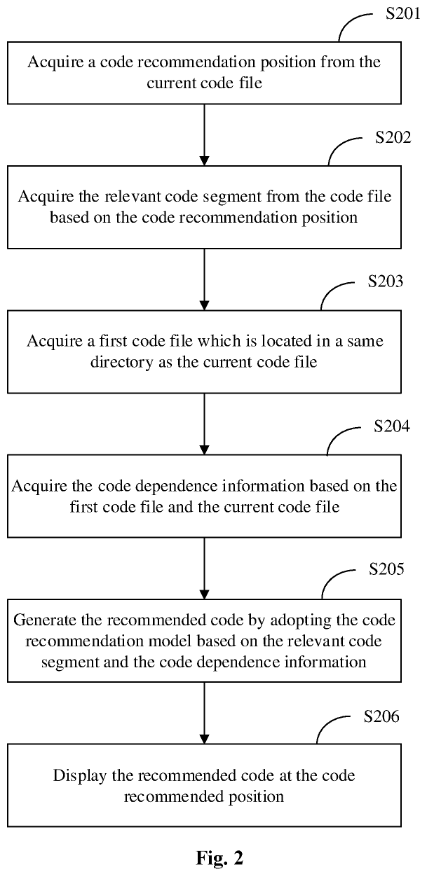

FIG. 2 is a schematic diagram according to a second embodiment of the present disclosure; the technical solution of the method for code recommendation according to the present embodiment of the present disclosure is further described in more detail based on the technical solution of the above-mentioned embodiment shown in FIG. 1. As shown in FIG. 2, the method for code recommendation according to the present embodiment may include the following steps:
S201: acquiring a code recommendation position from the current code file.

For example, the code recommendation position may be a position of a cursor in the current code file which indicates a position where the cursor stays in the development process of the research and development person, i.e., a development progress position, and after the position, codes are also required to be continuously written. In order to accelerate the development progress, in the method for code recommendation according to the present embodiment, the code is recommended at the position of the cursor, such that the research and development person can conveniently adopt the recommended code.
S202: acquiring the relevant code segment from the code file based on the code recommendation position.

In the present embodiment, the relevant code segment refers to a code segment relevant to the code at the code recommendation position. Since no code is written at the code recommendation position at this point, in the present embodiment, the relevant code segment can be acquired based on the code recommendation position when the code of the code recommendation position is predicted, such that reference may be made when the recommended code at the code recommendation position is predicted.

In the present embodiment, the relevant code segment is obtained from the code file based on the code recommendation position, which can realize accurate positioning and effectively ensure accuracy of the obtained relevant code segment.

The relevant code segment of the present embodiment may refer to context codes of the code at the code recommendation position, and specifically may include a previous code, a following code or both the previous code and the following code.

For example, during specific implementation, the step S202 may include: obtaining the relevant code segment from a code before the code recommendation position in the code file; that is, the corresponding relevant code segment may be the previous code at this point.

Or the step S202 may include: acquiring the relevant code segments from the codes before and after the code recommendation position in the code file. That is, the corresponding relevant code segments may be the context codes at this point.

For example, in practical application, when the relevant code segment is obtained, if a number of code lines before the code recommendation position does not reach a preset number threshold, all the codes before the code recommendation position may be obtained and included in the relevant code segment. If the number of the code lines before the code recommendation position exceeds the preset number threshold, only part of the codes can be selected according to a first preset rule and included in the relevant code segment. Specifically, the first preset rule may define selected content, for example, may define selection of n nearest lines of codes before the current position, and may further define selection of a code line describing dependence service, or the like. The first preset rule may be defined according to an actual scenario or an actual requirement, and is not limited herein.

Similarly, when the relevant code segment includes the following code, if a number of code lines after the code recommendation position does not reach the preset number threshold, all the codes after the code recommendation position may be obtained and included in the relevant code segment. If the number of the code lines after the code recommendation position exceeds the preset number threshold, only part of the codes can be selected according to a second preset rule and included in the relevant code segment. A setting principle of the second preset rule is the same as that of the first preset rule, and is not repeated herein.

No matter which way is adopted to acquire the relevant code segment, accuracy of the acquired relevant code segment can be effectively ensured.

Steps S201-S202 are a specific implementation of step S101 in the above-mentioned embodiment shown in FIG. 1.
S203: acquiring a first code file which is located in a same directory as the current code file.
S204: acquiring the code dependence information based on the first code file and the current code file.

For example, during specific implementation, dependence information of the first code file and dependence information of the current code file may be obtained separately; then, based on the dependence information of the first code file and the dependence information of the current code file, a code segment which exists in the dependence information of the first code file but does not exist in the dependence information of the current code file is acquired as the code dependence information.

In an actual application scenario, codes with similar functions are generally organized in the form of modules, packages, files, or the like, such that files in the same directory have strong correlation. Based on this, in the present embodiment, the code dependence information can be acquired by referring to the first code file in the same directory, thus effectively guaranteeing reasonability, validity and accuracy of the acquired code dependence information. In the present embodiment, a number of the acquired first code files located in the same directory as the current code file is not limited, and may be one, two, or more. If more than two first code files are included, the code segments which exist in the dependence information of the first code files but do not exist in the dependence information of the current code file are required to be obtained to jointly form the code dependence information.
S205: generating the recommended code by adopting the code recommendation model based on the relevant code segment and the code dependence information.
S206: displaying the recommended code at the code recommended position.

In the present embodiment, the recommended code is displayed at the code recommendation position to realize code recommendation. At this point, the research and development person can directly adopt part or all of the recommended code based on the recommended code displayed at the position, use is quite convenient, and the development progress can be effectively accelerated.

Compared with the prior art that the recommended code is generated only by depending on the relevant code segment, in the present embodiment, the code recommendation model generates the recommended code by additionally referring to the code dependence information, such that the accuracy of the generated recommended code can be improved.

In the method for code recommendation according to the present embodiment, the code dependence information is obtained according to the first code file which is located in the same directory as the current code file and the current code file, such that the reasonability, the validity and the accuracy of the code dependence information can be effectively ensured, and then, the accuracy of the recommended code generated by adopting the code recommendation model based on the relevant code segment and the code dependence information can be effectively improved, thereby effectively increasing the adoption rate of the recommended code, and effectively improving the development efficiency.

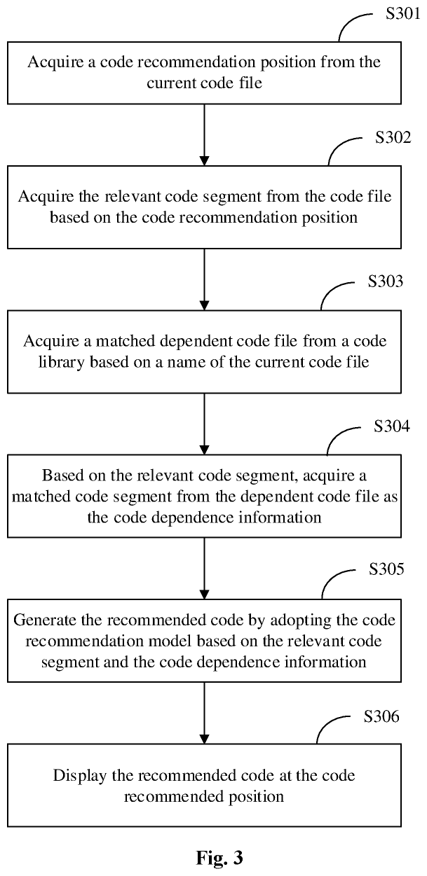

FIG. 3 is a schematic diagram according to a third embodiment of the present disclosure; the technical solution of the method for code recommendation according to the present embodiment of the present disclosure is further described in more detail based on the technical solution of the above-mentioned embodiment shown in FIG. 1. As shown in FIG. 3, the method for code recommendation according to the present embodiment may include the following steps:
S301: acquiring a code recommendation position from the current code file.
S302: acquiring the relevant code segment from the code file based on the code recommendation position.

For steps S301-S302, reference may be made to the steps S201-S202 in the above-mentioned embodiment shown in FIG. 2.
S303: acquiring a matched dependent code file from a code library based on a name of the current code file.

It is assumed that a file name in the code library is named using a snake case method or a camel case method, such as a code file of xxxController or xxxService. In the present embodiment, the matched dependent code file may be obtained from the code library based on the name of the code file. Since names of the current code file and the matched dependent code file have strong logical relevance, code content also has a high probability of correlation.

The matching of the present embodiment may include horizontal matching and longitudinal matching. For example, the code files xxxController and xxxService both include xxx, and the two code files may be considered to be matched horizontally. As another example, code files xxxController and yyyController both include Controller, and the two code files may be considered to be longitudinally matched.

According to the matching mode, all the dependent code files which are horizontally and longitudinally matched with the name of the current code file can be obtained from the code library.
S304: based on the relevant code segment, acquiring a matched code segment from the dependent code file as the code dependence information.

Specifically, based on lexical analysis, syntactic analysis, code feature extraction and other modes, a code analysis tool may be adopted to obtain a code segment matched with the relevant code segment in the dependent code file, and then, the code segment matched with the code segment at the code recommendation position can be obtained according to the code segment matched with the relevant code segment to serve as the code dependence information. Reference may be made to the prior art for the code analysis tool of the present embodiment, which is not limited herein.

For example, the relevant code segments include context code segments A and B, the dependent code file includes A1, C1 and B1, and after analysis, A is matched with A1, B is matched with B1, and at this point, the probability that the code at the code recommendation position is matched with the code segment C1 in the dependent code file may be considered to be quite high, and therefore, the code segment C1 may be acquired as the matched code segment at the code recommendation position, that is, as the code dependence information. The code dependence information acquired in this way can effectively ensure the reasonability, the validity and the accuracy of the code dependence information.

In an actual scenario, if a plurality of dependent code files are included, the code segments matched with all the dependent code files are required to be acquired to jointly form the code dependence information.
S305: generating the recommended code by adopting the code recommendation model based on the relevant code segment and the code dependence information.

Since the code dependence information includes the code segment in the dependent code file matched with the code segment at the code recommendation position, the code recommendation model can more accurately predict the code segment at the code recommendation position according to the relevant code segment and the code dependence information.
S306: displaying the recommended code at the code recommended position.

In the method for code recommendation according to the present embodiment, the matched code segment is acquired as the code dependence information from the dependent code file matched with the current code file, such that the reasonability, the validity and the accuracy of the code dependence information can be effectively ensured, and then, the accuracy of the recommended code generated by adopting the code recommendation model based on the relevant code segment and the code dependence information can be effectively improved, thereby effectively increasing the adoption rate of the recommended code, and effectively improving the development efficiency.

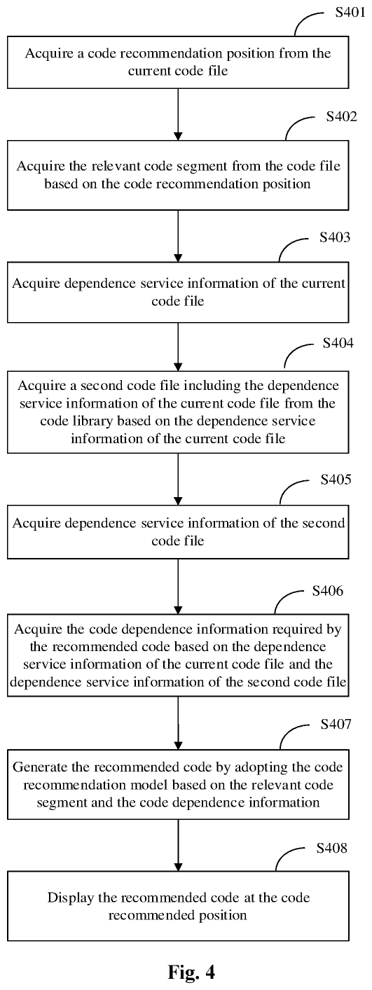

FIG. 4 is a schematic diagram according to a fourth embodiment of the present disclosure; the technical solution of the method for code recommendation according to the present embodiment of the present disclosure is further described in more detail based on the technical solution of the above-mentioned embodiment shown in FIG. 1. As shown in FIG. 4, the method for code recommendation according to the present embodiment may include the following steps:
S401: acquiring a code recommendation position from the current code file.
S402: acquiring the relevant code segment from the code file based on the code recommendation position.

For steps S401-S402, reference may be made to the steps S201-S202 in the above-mentioned embodiment shown in FIG. 2.
S403: acquiring dependence service information of the current code file.
S404: acquiring a second code file including the dependence service information of the current code file from the code library based on the dependence service information of the current code file.
S405: acquiring dependence service information of the second code file.
S406: acquiring the code dependence information required by the recommended code based on the dependence service information of the current code file and the dependence service information of the second code file.

For example, during specific implementation, service that the second code file depends on but the current code file does not depend on may be acquired as the code dependence information required by the recommended code based on the dependence service information of the current code file and the dependence service information of the second code file.

For example, if dependency on service C, D and E exists in the current code file A, and the second code file B is found to depend on service F while depending on the service C, D and E from the code library, the current code file A has a high probability of depending on the service F. At this point, the code dependence information which can be acquired may be dependency of the current code file A on the service F.

In an actual application scenario, the dependence service information of the code file is automatically generated in the code development process. The current code file is not completed, and therefore, the dependence service information is incomplete. At this point, dependence service that the current code file still possibly has can be inferred as the code dependence information by referring to dependence service of the second code file having the same dependence service as the current code file.

The code dependence information acquired in this way can effectively ensure the reasonability, the validity and the accuracy of the code dependence information.

In practical applications, a number of the second code files obtained in the above manner may be one, two or more. If more than two second code files are included, analysis is required to be performed on the basis of all the second code files in the above manner, so as to jointly obtain the code dependence information.
S407: generating the recommended code by adopting the code recommendation model based on the relevant code segment and the code dependence information.
S408: displaying the recommended code at the code recommended position.

In the method for code recommendation according to the present embodiment, the service which is not depended on by the current code file is obtained from the dependence service information of the second code file including the dependence service information of the current code file and is used as the code dependence information required by the recommended code, such that the reasonability, the validity and the accuracy of the code dependence information can be effectively ensured, and then, the accuracy of the recommended code generated by adopting the code recommendation model based on the relevant code segment and the code dependence information can be effectively improved, thereby effectively increasing the adoption rate of the recommended code, and effectively improving the development efficiency.

It should be noted that the code dependence information is obtained by the three different ways in the foregoing FIGS. 2-4, and in an actual application scenario, the three ways of obtaining the code dependence information may also be used in combination with each other. That is, any two or three of the above code dependence information may be used simultaneously to perform code recommendation. Moreover, the richer the content of the code dependence information, the higher the accuracy of the generated recommended code.

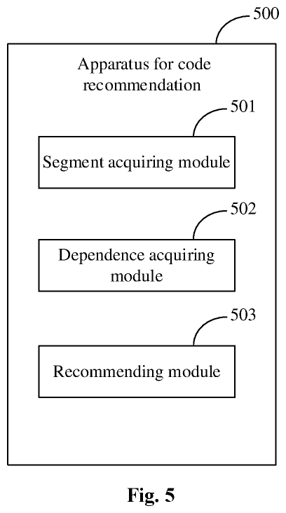

FIG. 5 is a schematic diagram according to a fifth embodiment of the present disclosure; as shown in FIG. 5, the present embodiment provides an apparatus 500 for code recommendation, including:
a segment acquiring module 501 configured to acquire a relevant code segment required by a recommended code from a current code file;
a dependence acquiring module 502 configured to acquire code dependence information required by the recommended code; and
a recommending module 503 configured to perform code recommendation based on the relevant code segment, the code dependence information and a pre-trained code recommendation model.

The apparatus 500 for code recommendation according to the present embodiment has the same implementation as the above-mentioned relevant method embodiment by adopting the above-mentioned modules to implement the implementation principle and the technical effects of the code recommendation, and for details, reference may be made to the description of the above-mentioned relevant method embodiment, and details are not repeated herein.

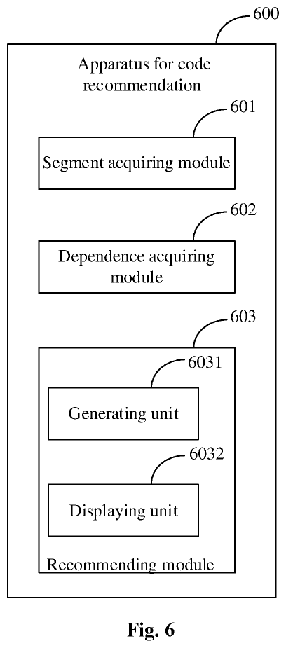

FIG. 6 is a schematic diagram according to a sixth embodiment of the present disclosure; as shown in FIG. 6, the present embodiment provides an apparatus 600 for code recommendation, including modules with same names and functions as those in FIG. 5 above: a segment acquiring module 601, a dependence acquiring module 602 and a recommending module 603.

Further, as shown in FIG. 6, in the apparatus 600 for code recommendation according to the present embodiment, the recommending module 603 includes:
a generating unit 6031 configured to generate the recommended code by adopting the code recommendation model based on the relevant code segment and the code dependence information; and
a displaying unit 6032 configured to display the recommended code at the code recommended position.

Further optionally, in the present embodiment, the segment acquiring module 601 is configured to:
acquire a code recommendation position from the current code file; and
acquire the relevant code segment from the code file based on the code recommendation position.

Further optionally, in the present embodiment, the segment acquiring module 601 is configured to:
acquire the relevant code segment from a code before the code recommendation position in the code file; or
acquire the relevant code segments from the codes before and after the code recommendation position in the code file.

Further optionally, in the present embodiment, the dependence acquiring module 602 is configured to:
acquire a first code file which is located in a same directory as the current code file; and
acquire the code dependence information based on the first code file and the current code file.

Further optionally, in the present embodiment, the dependence acquiring module 602 is configured to:
acquire dependence information of the first code file and dependence information of the current code file separately; and
based on the dependence information of the first code file and the dependence information of the current code file, acquire a code segment which exists in the dependence information of the first code file but does not exist in the dependence information of the current code file as the code dependence information.

Further optionally, in the present embodiment, the dependence acquiring module 602 is configured to:
acquire a matched dependent code file from a code library based on a name of the current code file; and
based on the relevant code segment, acquire a matched code segment from the dependent code file as the code dependence information.

Further optionally, in the present embodiment, the dependence acquiring module 602 is configured to:
acquire dependence service information of the current code file;
acquire a second code file including the dependence service information of the current code file from the code library based on the dependence service information of the current code file;
acquire dependence service information of the second code file; and
acquire the code dependence information required by the recommended code based on the dependence service information of the current code file and the dependence service information of the second code file.

Further optionally, in the present embodiment, the dependence acquiring module 602 is configured to:
acquire service that the second code file depends on but the current code file does not depend on as the code dependence information required by the recommended code based on the dependence service information of the current code file and the dependence service information of the second code file.

The apparatus 600 for code recommendation according to the present embodiment has the same implementation as the above-mentioned relevant method embodiment by adopting the above-mentioned modules to implement the implementation principle and the technical effects of the code recommendation, and for details, reference may be made to the description of the above-mentioned relevant method embodiment, and details are not repeated herein.

In the technical solution of the present disclosure, the acquisition, storage and application of involved user personal information are in compliance with relevant laws and regulations, and do not violate public order and good customs.

According to the embodiment of the present disclosure, there are also provided an electronic device, a readable storage medium and a computer program product.

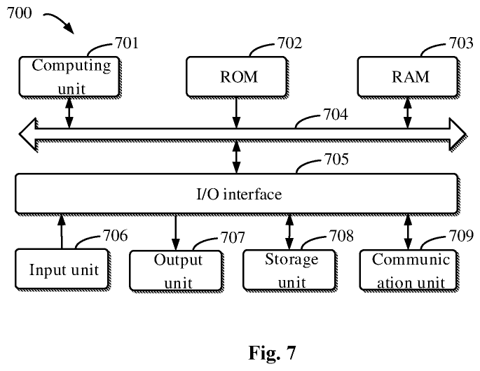

FIG. 7 shows a schematic block diagram of an exemplary electronic device 700 which may be configured to implement the embodiment of the present disclosure. The electronic device is intended to represent various forms of digital computers, such as laptop computers, desktop computers, workstations, personal digital assistants, servers, blade servers, mainframe computers, and other appropriate computers. The electronic device may also represent various forms of mobile apparatuses, such as personal digital assistants, cellular telephones, smart phones, wearable devices, and other similar computing apparatuses. The components shown herein, their connections and relationships, and their functions, are meant to be exemplary only, and are not meant to limit implementation of the present disclosure described and/or claimed herein.

As shown in FIG. 7, the device 700 includes a computing unit 701 which may perform various appropriate actions and processing operations according to a computer program stored in a read only memory (ROM) 702 or a computer program loaded from a storage unit 708 into a random access memory (RAM) 703. Various programs and data necessary for the operation of the device 700 may be also stored in the RAM 703. The computing unit 701, the ROM 702, and the RAM 703 are connected with one other through a bus 704. An input/output (I/O) interface 705 is also connected to the bus 704.

The plural components in the device 700 are connected to the I/O interface 705, and include: an input unit 706, such as a keyboard, a mouse, or the like; an output unit 707, such as various types of displays, speakers, or the like; the storage unit 708, such as a magnetic disk, an optical disk, or the like; and a communication unit 709, such as a network card, a modem, a wireless communication transceiver, or the like. The communication unit 709 allows the device 700 to exchange information/data with other devices through a computer network, such as the Internet, and/or various telecommunication networks.

The computing unit 701 may be a variety of general and/or special purpose processing components with processing and computing capabilities. Some examples of the computing unit 701 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, or the like. The computing unit 701 performs the methods and processing operations described above, such as the method according to the present disclosure. For example, in some embodiments, the method according to the present disclosure may be implemented as a computer software program tangibly contained in a machine readable medium, such as the storage unit 708. In some embodiments, part or all of the computer program may be loaded and/or installed into the device 700 via the ROM 702 and/or the communication unit 709. When the computer program is loaded into the RAM 703 and executed by the computing unit 701, one or more steps of the method according to the present disclosure may be performed. Alternatively, in other embodiments, the computing unit 701 may be configured to perform the method according to the present disclosure by any other suitable means (for example, by means of firmware).

Various implementations of the systems and technologies described herein above may be implemented in digital electronic circuitry, integrated circuitry, field programmable gate arrays (FPGA), application specific integrated circuits (ASIC), application specific standard products (ASSP), systems on chips (SOC), complex programmable logic devices (CPLD), computer hardware, firmware, software, and/or combinations thereof. The systems and technologies may be implemented in one or more computer programs which are executable and/or interpretable on a programmable system including at least one programmable processor, and the programmable processor may be special or general, and may receive data and instructions from, and transmit data and instructions to, a storage system, at least one input apparatus, and at least one output apparatus.

Program codes for implementing the method according to the present disclosure may be written in any combination of one or more programming languages. These program codes may be provided to a processor or a controller of a general purpose computer, a special purpose computer, or other programmable data processing apparatuses, such that the program code, when executed by the processor or the controller, causes functions/operations specified in the flowchart and/or the block diagram to be implemented. The program code may be executed entirely on a machine, partly on a machine, partly on a machine as a stand-alone software package and partly on a remote machine, or entirely on a remote machine or a server.

In the context of the present disclosure, the machine readable medium may be a tangible medium which may contain or store a program for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the foregoing.

To provide interaction with a user, the systems and technologies described here may be implemented on a computer having: a display apparatus (for example, a cathode ray tube (CRT) or liquid crystal display (LCD) monitor) for displaying information to a user; and a keyboard and a pointing apparatus (for example, a mouse or a trackball) by which a user may provide input for the computer. Other kinds of apparatuses may also be used to provide interaction with a user; for example, feedback provided for a user may be any form of sensory feedback (for example, visual feedback, auditory feedback, or tactile feedback); and input from a user may be received in any form (including acoustic, speech or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a local area network (LAN), a wide area network (WAN) and the Internet.

A computer system may include a client and a server. Generally, the client and the server are remote from each other and interact through the communication network. The relationship between the client and the server is generated by virtue of computer programs which run on respective computers and have a client-server relationship to each other. The server may be a cloud server or a server of a distributed system, or a server incorporating a blockchain.

It should be understood that various forms of the flows shown above may be used and reordered, and steps may be added or deleted. For example, the steps described in the present disclosure may be executed in parallel, sequentially, or in different orders, which is not limited herein as long as the desired results of the technical solution disclosed in the present disclosure may be achieved.

The above-mentioned implementations are not intended to limit the scope of the present disclosure. It should be understood by those skilled in the art that various modifications, combinations, sub-combinations and substitutions may be made, depending on design requirements and other factors. Any modification, equivalent substitution and improvement made within the spirit and principle of the present disclosure all should be included in the extent of protection of the present disclosure.

What is claimed is:

1. A method for code recommendation, comprising:
acquiring a relevant code segment required by a recommended code from a current code file;
acquiring code dependence information required by the recommended code; and
performing code recommendation based on the relevant code segment, the code dependence information and a pre-trained code recommendation model.

2. The method according to claim 1, wherein the performing code recommendation based on the relevant code segment, the code dependence information and a pre-trained code recommendation model comprises:
generating the recommended code by adopting the code recommendation model based on the relevant code segment and the code dependence information; and
displaying the recommended code at the code recommended position.

3. The method according to claim 1, wherein the acquiring a relevant code segment required by a recommended code from a current code file comprises:
acquiring a code recommendation position from the current code file; and
acquiring the relevant code segment from the code file based on the code recommendation position.

4. The method according to claim 3, wherein the acquiring the relevant code segment from the code file based on the code recommendation position comprises:
acquiring the relevant code segment from a code before the code recommendation position in the code file; or
acquiring the relevant code segments from the codes before and after the code recommendation position in the code file.

5. The method according to claim 1, wherein the acquiring code dependence information required by the recommended code comprises:
acquiring a first code file which is located in a same directory as the current code file; and
acquiring the code dependence information based on the first code file and the current code file.

6. The method according to claim 5, wherein the acquiring the code dependence information based on the first code file and the current code file comprises:
acquiring dependence information of the first code file and dependence information of the current code file separately; and
based on the dependence information of the first code file and the dependence information of the current code file, acquiring a code segment which exists in the dependence information of the first code file but does not exist in the dependence information of the current code file as the code dependence information.

7. The method according to claim 1, wherein the acquiring code dependence information required by the recommended code comprises:
acquiring a matched dependent code file from a code library based on a name of the current code file; and
based on the relevant code segment, acquiring a matched code segment from the dependent code file as the code dependence information.

8. The method according to claim 1, wherein the acquiring code dependence information required by the recommended code comprises:
acquiring dependence service information of the current code file;
acquiring a second code file comprising the dependence service information of the current code file from the code library based on the dependence service information of the current code file;
acquiring dependence service information of the second code file; and
acquiring the code dependence information required by the recommended code based on the dependence service information of the current code file and the dependence service information of the second code file.

9. The method according to claim 8, wherein the acquiring the code dependence information required by the recommended code based on the dependence service information of the current code file and the dependence service information of the second code file comprises:
acquiring service that the second code file depends on but the current code file does not depend on as the code dependence information required by the recommended code based on the dependence service information of the current code file and the dependence service information of the second code file.

10. An electronic device, comprising:
at least one processor; and
a memory communicatively connected with the at least one processor;
wherein the memory stores instructions executable by the at least one processor, and the instructions are executed by the at least one processor to enable the at least one processor to perform a method for code recommendation, wherein the method for code recommendation comprises:
acquiring a relevant code segment required by a recommended code from a current code file;
acquiring code dependence information required by the recommended code; and
performing code recommendation based on the relevant code segment, the code dependence information and a pre-trained code recommendation model.

11. The electronic device according to claim 10, wherein the performing code recommendation based on the relevant code segment, the code dependence information and a pre-trained code recommendation model comprises:
generating the recommended code by adopting the code recommendation model based on the relevant code segment and the code dependence information; and
displaying the recommended code at the code recommended position.

12. The electronic device according to claim 10, wherein the acquiring a relevant code segment required by a recommended code from a current code file comprises:
acquiring a code recommendation position from the current code file; and
acquiring the relevant code segment from the code file based on the code recommendation position.

13. The electronic device according to claim 12, wherein the acquiring the relevant code segment from the code file based on the code recommendation position comprises:
acquiring the relevant code segment from a code before the code recommendation position in the code file; or
acquiring the relevant code segments from the codes before and after the code recommendation position in the code file.

14. The electronic device according to claim 10, wherein the acquiring code dependence information required by the recommended code comprises:
acquiring a first code file which is located in a same directory as the current code file; and
acquiring the code dependence information based on the first code file and the current code file.

15. The electronic device according to claim 14, wherein the acquiring the code dependence information based on the first code file and the current code file comprises:
acquiring dependence information of the first code file and dependence information of the current code file separately; and
based on the dependence information of the first code file and the dependence information of the current code file, acquiring a code segment which exists in the dependence information of the first code file but does not exist in the dependence information of the current code file as the code dependence information.

16. The electronic device according to claim 10, wherein the acquiring code dependence information required by the recommended code comprises:
acquiring a matched dependent code file from a code library based on a name of the current code file; and
based on the relevant code segment, acquiring a matched code segment from the dependent code file as the code dependence information.

17. The electronic device according to claim 10, wherein the acquiring code dependence information required by the recommended code comprises:
acquiring dependence service information of the current code file;
acquiring a second code file comprising the dependence service information of the current code file from the code library based on the dependence service information of the current code file;
acquiring dependence service information of the second code file; and
acquiring the code dependence information required by the recommended code based on the dependence service information of the current code file and the dependence service information of the second code file.

18. The electronic device according to claim 17, wherein the acquiring the code dependence information required by the recommended code based on the dependence service information of the current code file and the dependence service information of the second code file comprises:
acquiring service that the second code file depends on but the current code file does not depend on as the code dependence information required by the recommended code based on the dependence service information of the current code file and the dependence service information of the second code file.

19. A non-transitory computer readable storage medium with computer instructions stored thereon, wherein the computer instructions are used for causing a method for code recommendation, wherein the method for code recommendation comprises:
acquiring a relevant code segment required by a recommended code from a current code file;
acquiring code dependence information required by the recommended code; and
performing code recommendation based on the relevant code segment, the code dependence information and a pre-trained code recommendation model.

20. The non-transitory computer readable storage medium according to claim 19, wherein the performing code recommendation based on the relevant code segment, the code dependence information and a pre-trained code recommendation model comprises:
generating the recommended code by adopting the code recommendation model based on the relevant code segment and the code dependence information; and
displaying the recommended code at the code recommended position.
